(19) United States
(12) Patent Application Publication
(10) Pub. No.: US 2026/0203106 A1
(43) Pub. Date: Jul. 16, 2026

(54) Full Lifecycle AI Workload Deployment with Cost and Performance Optimization Through Performance Prediction

(71) Applicant: Systalyze Inc., Cambridge, MA (US)

(72) Inventors: Manya Ghobadi, Cambridge, MA (US); Sudarsanan Rajasekaran, Cambridge, MA (US); Armin Ghobadi, Cambridge, MA (US)

(73) Assignee: Systalyze Inc., Cambridge, MA (US)

(21) Appl. No.: 19/449,222

(22) Filed: Jan. 14, 2026

Related U.S. Application Data
(60) Provisional application No. 63/745,443, filed on Jan. 15, 2025.

(51) Int. Cl. G06F 9/48; G06F 11/30; G06F 11/34

(52) U.S. Cl. CPC G06F 9/4881; G06F 11/302; G06F 11/3414

(57) ABSTRACT

Techniques relating to full lifecycle AI workload deployment and optimization are disclosed. A system for deploying artificial intelligence (AI) workloads include a predictive modeling engine to provide an optimized deployment prediction representing a lowest cost, highest performance deployment, and a monitoring component comprising a data collection module to collect fine-grain GPU utilization data, an architecture identification module, an analysis module to determine an actual GPU utilization and efficiency based on the GPU utilization data and the AI model architecture. The system also includes a performance optimization application to implement workload placement adjustments (e.g., moving and scheduling data across a full stack implementation of the AI infrastructure) according to insights from the monitoring component derived from a deployment according to the optimized deployment prediction. In some examples, the system further includes a deployment component and a troubleshooting component.

### CROSS-REFERENCE TO RELATED APPLICATIONS

This application claims the benefit of U.S. Provisional Patent Application No. 63/745,443 entitled “Full Lifecycle AI Workload Orchestration and Cost Optimization Through Performance Prediction,” filed Jan. 15, 2025, the contents of which are hereby incorporated by reference in their entirety.

### BACKGROUND OF INVENTION

Enterprises face significant capital and operational challenges when attempting to implement artificial intelligence (AI) solutions. These challenges include (1) setup complexity: spending weeks fighting package installations, debugging drivers, and navigating outdated repositories, and (2) cost, energy, and performance uncertainty - no reliable way to predict the performance, cost, and energy requirements of AI deployments inside their organization. Compute, network, and storage resources are often shared among multiple jobs and users, leading to competition and contention. Compounding these challenges is the acute shortage of highly trained AI systems engineers, which creates inefficiencies and limits the scalability of AI workloads. Organizations are forced to allocate resources without adequate expertise or tools to optimize their utilization. The business impact is a concerning trend that has emerged in the development of AI initiatives, with many projects stalled in the planning phase for months. This prolonged delay not only results in wasted cost, but also in preventing the exploration of promising use cases that could have been attempted, ultimately hindering the potential benefits and advancements that AI could have brought.

The first major challenge faced by enterprises is lack of accurate performance and cost prediction for AI deployment solutions. This results in vendor lock-in, affecting purchasing decisions on software packages, network technology, compute hardware, and even cloud providers. Companies often make multi-million-dollar purchasing decisions without fully understanding how these decisions impact performance. They lack the tools necessary to evaluate alternative options based on a deep understanding of workload requirements. This results in inflexible systems that are difficult to optimize or migrate.

Additionally, current AI systems lack robust tools for efficient deployment, monitoring, and debugging of AI workloads. For example, there are no comprehensive tools to deploy AI jobs efficiently or to detect and fix performance bottlenecks. This leads to wasted GPU cycles and significant engineering overhead. In particular, the current inefficiencies in deploying AI workloads involve several manual steps including selecting an AI model without guidance on which model is best suited for the use case, manually selecting the number of GPUs required for the task, and manually installing necessary software packages, libraries, and hyperparameters. Once deployed, users must manually configure and optimize their AI system using popular AI deployment tools, but often with suboptimal performance due to manual configuration. This leads to low performance, constant manual configuration overheads, and performance monitoring challenges, resulting in wasted GPU cycles and significant engineering overhead, highlighting the need for effective robust tools for efficient deployment, monitoring, and debugging of AI workloads.

Finally, there is no semantic-aware performance monitoring tool to help organizations correctly monitor the actual GPU utilizations. In particular, today's popular GPU utilization monitoring tools (e.g., NVIDIA's nvidia-smi) overestimate the GPU utilization and report significantly higher GPU utilizations. This overestimation can hinder performance optimization, as engineers may stop exploring optimization opportunities under the assumption that the GPU is already fully saturated. Moreover, inflated utilization metrics can obscure system bottlenecks and GPU idle periods, preventing optimization algorithms from identifying and addressing performance inefficiencies.

Therefore, a full lifecycle AI workload deployment with cost and performance optimization through performance prediction desirable.

### BRIEF SUMMARY

A system and method are disclosed for a full lifecycle AI workload deployment with cost and performance optimization through performance prediction. A system for deploying artificial intelligence (AI) workloads may include: a server implementing a memory comprising non-transitory computer-readable storage medium and one or more processors, the memory comprising non-transitory computer-readable storage medium configured to store an AI model, a dataset, and processing unit (GPU) utilization data, the one or more processors configured to execute instructions stored on the non-transitory computer-readable storage medium to implement: a predictive modeling engine to provide an optimized deployment prediction comprising a lowest cost, highest performance deployment, a data collection module to collect the GPU utilization data on performance of the AI model under a plurality of scenarios, an architecture identification module to identify an AI model architecture associated with the AI model, an analysis module to determine an actual GPU utilization and efficiency based on the GPU utilization data and the AI model architecture, a performance optimization application to implement workload placement adjustments, including moving and scheduling data across a full stack implementation of an AI infrastructure associated with the AI model architecture. In some examples, the lowest cost, highest performance deployment comprises an optimized hyperparameter and an optimized resource placement for an AI job. In some examples, the server comprises one, or a combination of, an on-premise server, a cloud server, and a hybrid server. In some examples, the GPU utilization data comprises fine-grain utilization data including a number of threads or warps being executed at a given point in time within a GPU. In some examples, the GPU utilization data comprises one, or a combination, of GPU and kernel metrics, CUDA events, and GPU hardware counters. In some examples, the architecture identification module is configured to use one or both of a machine learning algorithm and a database lookup to identify the AI model architecture. In some examples, the one or more processors is further configured to execute instructions to implement a deployment module to deploy an AI job using the optimized deployment prediction. In some examples, the deployment module is configured to integrate open source and/or proprietary tools to deploy the AI job.

In some examples, the one or more processors is further configured to execute instructions to implement a troubleshooting component to perform semantic-aware analysis of an operation graph and comparison of execution time against the prediction by the predictive modeling engine. In some examples, the operation graph comprises a computation graph. In some examples, the computation graph is a Directed Acyclic Graph (DAG). In some examples, the troubleshooting component is configured to compare a predicted execution time of the optimized deployment prediction with an actual metric of the actual GPU utilization and efficiency to identify a performance bottleneck.

In some examples, the predictive modeling engine is configured to perform one, or a combination, of mathematical modeling, simulations, hardware profiling, and software profiling to enhance resource forecasting and accuracy in the optimized deployment prediction. In some examples, the predictive modeling engine is configured to convert the AI model into a custom graph format wherein each node represents a compute operation and each edge represents a data dependency between nodes. In some examples, the predictive modeling engine is configured to extract a computation graph from the AI model, and to update the computation graph based on a hyperparameter. In some examples, the computation graph comprises a Directed Acyclic Graph (DAG). In some examples, the predictive modeling engine is configured to perform single accelerator projection, including profiling on a single hardware accelerator and projecting execution times across different parallelization strategies. In some examples, the analysis module is configured to perform semantic graph analysis on a computation graph representing the AI model to determine and record performance metrics for each computation operation in the AI model. In some examples, the optimized deployment prediction reflects one, or a combination, of a parallelization strategy, a learning rate, a job placement strategy, a result of a collective communication operation, a global batch size, and a local batch size.

### BRIEF DESCRIPTION OF THE DRAWINGS

Various non-limiting and non-exhaustive aspects and features of the present disclosure are described hereinbelow with references to the drawings, wherein:

FIG. 1 is a simplified block diagrams illustrating exemplary components of a full lifecycle AI workload deployment with cost and performance optimization through performance prediction, in accordance with one or more embodiments.

FIG. 2 is a flow diagram illustrating an exemplary inputs and outputs to a performance prediction modeling component of a full lifecycle AI workload deployment with cost and performance optimization, in accordance with one or more embodiments.

FIG. 3A is a simplified block diagram illustrating exemplary modules in a monitoring component of a full lifecycle AI workload deployment with cost and performance optimization, in accordance with one or more embodiments.

FIG. 3B is a chart showing true GPU utilization and efficiency as monitored by a full lifecycle AI workload deployment with cost and performance optimization, in accordance with one or more embodiments.

FIG. 4A is a simplified block diagram illustrating an exemplary full stack system-level optimization by a full lifecycle AI workload deployment, in accordance with one or more embodiments.

FIG. 4B is a simplified system diagram illustrating a multi-tenancy scenario, in accordance with one or more embodiments.

FIG. 5 is a chart showing true GPU utilization and efficiency of a full lifecycle AI workload deployment with cost and performance optimization, in accordance with one or more embodiments.

FIG. 6 is a flow diagram illustrating a method for generating an optimized deployment prediction in a full lifecycle AI workload deployment with cost and performance optimization, in accordance with one or more embodiments.

FIG. 7 is a flow diagram illustrating a method for determining actual GPU utilization and efficiency in a full lifecycle AI workload deployment with cost and performance optimization, in accordance with one or more embodiments.

FIG. 8A is a simplified block diagram of an exemplary computing system configured to implement the systems shown in FIGS. 1-2, 3A, 4A-4B and to perform steps of the method illustrated in FIGS. 6-7, in accordance with one or more embodiments.

FIG. 8B is a simplified block diagram of an exemplary distributed computing system implemented by a plurality of the computing devices, in accordance with one or more embodiments.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to a full lifecycle artificial intelligence (AI) workload deployment with cost and performance optimization. This innovation addresses the challenges faced by companies, institutions, organizations, and other entities struggling with resource allocation for implementing AI solutions, without adequate expertise or tools to optimize utilization, by building a full lifecycle AI workload deployment and optimization through performance prediction. The framework and system described herein comprise a predictive modeling component, a deployment component, a monitoring component, a troubleshooting component, and an optimization component.

Techniques described herein include a framework (e.g., system, tool, solution) that integrates predictive modeling, dynamic deployment, sematic-aware monitoring and troubleshooting, and resource optimization. This AI workload deployment system addresses shortcomings of existing solutions and enables enterprises to deploy AI workloads with higher efficiency and lower costs. The AI workload deployment framework and system described herein may be applied to both traditional AI models (e.g., deep neural networks (DNNs), convolutional neural networks (CNNs), and other classification and regression models) and modern models (e.g., large language models (LLMs) and other transformer models, generative models, reasoning models, and the like).

Optimized deployment of any AI workload depends on several variables, including budget, available resources, architecture of the AI model, desired accuracy, time constraints, job priority, and target service-level agreements. These variables change continuously as jobs and users arrive and depart, or as failures and stragglers impact resource availability. Without a semantic-aware and real-time evaluation and reallocation of resources, performance and efficiency suffer.

To address these challenges, a “clairvoyant” and “semantic-aware” solution is required—one that monitors real-time resource utilization across clusters (e.g., in a semantic-aware manner that captures behavior under varying scenarios), predicts the requirements of incoming jobs (i.e., clairvoyant), and evaluates the expected impact of new deployments on overall performance. Such a system ensures efficient resource sharing, minimizes bottlenecks, and optimizes throughput by adapting to system dynamics in real time. By providing granular insights and predictive capabilities, this invention transforms AI workload deployment into a streamlined, efficient process. The techniques described herein are applicable to training, fine-tuning, inference, and agentic workloads.

Beyond the improvements in performance and cost advantages, this invention also cuts the carbon footprint of AI workloads. The key reason is that this framework helps to complete AI tasks faster. Since graphics processing units (GPUs) consume roughly constant power while active, shorter runtimes directly translate into lower total energy (i.e., power×time) usage.

FIG. 1 is a simplified block diagrams illustrating exemplary components of a full lifecycle AI workload deployment with cost and performance optimization through performance prediction, in accordance with one or more embodiments. In diagram 100, a full lifecycle AI workload deployment being implemented in server 101 (e.g., on premise server(s), cloud server, other cloud computing resource or virtual server, hybrid server resources, etc.) may include a predictive modeling component 102, a deployment component 104, a monitoring component 106, a troubleshooting component 108, and a performance optimization component 110. Using this implementation, dynamic adjustments to deployment strategies may be made based on real-time system states. As jobs and/or users arrive, complete jobs, and encounter failures, system 100 is configured to recalibrate its strategy to optimize resource utilization and meet budget and performance goals.

The predictive modeling component 102 may be configured to anticipate resource requirements based on factors such as AI model architecture, dataset properties, desired accuracy and other performance metrics (e.g., throughput, latency, etc.), time constraints, cost budgets, and priority. By leveraging this predictive capability, system 100 ensures efficient allocation of resources while minimizing delays and over-provisioning.

In some examples, predictive modeling component 102 may be configured to convert an AI model to a Directed Acyclic Graph (DAG). AI workloads require processing data through multiple layers of the model repeatedly (e.g., layer-after-layer). This iterative process of computation, data movement, and model updates can be represented in a DAG (or other computation graph) of compute and data operations. For example, to extract the DAG for a given AI workload, the model may be converted from a native format (e.g., PyTorch, TensorFlow, Keras, Caffe, JAX, MXNet) into another format, such as the Open Neural Network Exchange (ONNX) or a custom graph format where each node represents a compute operation (e.g., matrix multiplication, transformer block, etc.) and the edges represent the data dependency between connecting nodes. This format conversion facilitates the extraction of operations into a DAG enabling a more structured representation of the workload. Once the DAG is extracted from the format-converted model, the DAG may be updated based on model hyperparameters such as batch size, parallelization strategy, and optimizer algorithm. This update process may include injecting nodes into the DAG to represent intra-node and inter-node data communication. This update process also may include partitioning compute operations according to a chosen model parallelization strategy. A resulting refined DAG provides an accurate representation of all the operations in an AI workload.

In some examples, predictive modeling component 102 may be configured to perform mathematical modeling using the refined DAG. For example, each node in the refined DAG structure may indicate an operation of type compute, communication, or memory access. The execution time of each of these DAG nodes may be formulated based on a type of operation and specifications of the underlying infrastructure and hardware. Then, to predict required computation time of the AI model, predictive modeling component 102 may:
Model computation requirements of each operation of the AI model in a forward path, backpropagation, and collective communication phase;
Represent the behavior of hardware components and software stack using mathematical formulations;
Compute a runtime of the critical path of the computation graph (e.g., DAG) for any potential parallelization strategies given the infrastructure parameters; and
Predict a sequence of compute operations (e.g., CUDA (Compute Unified Device Architecture) calls in Nvidia GPUs) involved in the AI workload along with an expected runtime for each operation. The sequence of compute operations and the expected runtime for each operation may be used to troubleshoot performance issues, as described below, by comparing predicted runtimes with observed runtimes of the compute operations.

In some examples, the mathematical formulas used by predictive modeling component 102 may incorporate a comprehensive set of hardware-and model-specific parameters, including GPU FLOP capacity, hardware micro-architecture details, pipeline, tensor- and data-parallel dimensions, the portion of parallelism mapped to different links (e.g., within a server, across servers), embedding dimension, sequence length, number of interleaved stages, bandwidth between GPUs (e.g., within a server, across servers), network bandwidth, PCI-E bandwidth, number and size of each layer in the architecture of the model (e.g., transformer-block layers, non-transformer layers), per-layer parameter counts, micro-batch size per pipeline, micro-batches per iteration, etc. These formulations can be derived from (i) profiling-based calibration of representative kernels, (ii) multidimensional interpolation of the calibrated performance coefficients across the parameter space, and (iii) lightweight event-driven simulation that captures resource contention and scheduling effects, or other similar approaches. By applying this combination, the mathematical formulations may compute forward-pass time, backward-pass time, bubble time, synchronization time, pipeline drain time, memory for model weights, memory for activation, memory for KV cache, etc., thereby predicting overall execution latency, memory and bandwidth requirements, and near-optimal hyper-parameters and parallelization strategy for a given deployment scenario.

In other examples, predictive modeling component 102 may be configured to implement simulation software to increase the fidelity of the mathematical formulations. For example, an event-driven simulation software may be employed to capture the behavior of the system infrastructure for deploying the AI model (including network switches, packet buffers, congestion control algorithms, multi-tenancy, etc.) and multi-tenancy behaviors. Inputs to the simulation software may include: a computation graph of each AI (e.g., DAG), jobs and users arrive processes, and capabilities of infrastructure components and software stacks. The simulation software may process these inputs to estimate the resource requirements of each AI model, as well as performance metrics (e.g., throughput, latency, job finish times, etc.), thereby providing a comprehensive view of system performance (e.g., GPU utilization, network utilization, etc.) under various scenarios.

In some examples, predictive modeling component 102 also may be configured to profile execution time of different AI operations on real-world hardware to enhance prediction accuracy. For example, predictive modeling component 102 may perform single accelerator projection, including profiling on a single hardware accelerator and projecting execution times across different parallelization strategies for scalable predictions. Additionally, or alternatively, predictive modeling component 102 may perform operation deduplication, including profiling only unique operations in an AI model by identifying repeated patterns, wherein execution time of the entire AI model is then projected by integrating the computation graph (e.g., DAG) with profiled metrics of unique operations.

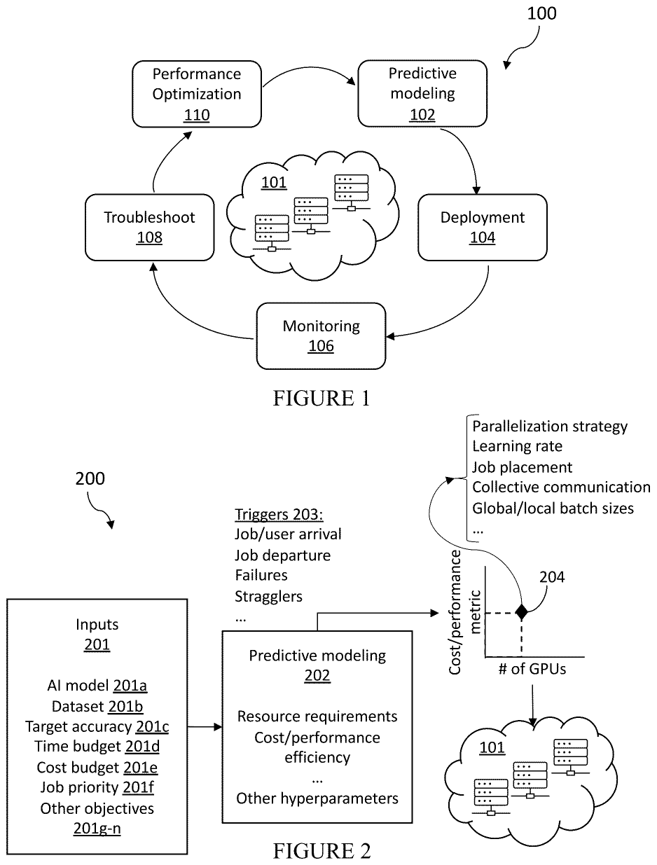

FIG. 2 is a flow diagram illustrating an exemplary inputs and outputs to a performance prediction engine component of a full lifecycle AI workload deployment with cost and performance optimization, in accordance with one or more embodiments. As shown in diagram 200, inputs 201 may be provided to predictive modeling engine 202 configured to predict one, or a combination, of resource requirements, cost efficiency, performance efficiency, and other hyper-parameters. In some examples, predictive modeling engine 202 may be implemented by, or as part of, predictive modeling component 102 in FIG. 1. In some examples, inputs 201 may include AI model 201a, dataset 201b, target accuracy 201c, time budget 201d, cost budget 201e, job priority 201f, and other objectives 201g-n. Predictive modeling engine 202 may be configured to extract from the AI model, or convert the AI model to, a DAG or other computation graph representation. Predictive modeling engine 202 may consider triggers 203 in determining a lowest cost, highest performance deployment prediction 204 for AI model 201a. In some examples, triggers 203 may include job arrival, user arrival, job departure, failure instance, straggler, and the like. Lowest cost, highest performance deployment prediction 204 may reflect hyperparameters such as a parallelization strategy, a learning rate, a job placement strategy, results of a collective communication operation (e.g., AllReduce collective), global and local batch sizes, and other parameters (e.g., requirements). Predictive modeling engine 202 may be configured to iterate (e.g., model computation requirements, compute runtimes, etc.) over all possible resource requirements, cost and performance metrics, and hyperparameters to generate an optimized deployment prediction (i.e., the lowest cost, highest performance deployment prediction 204), including optimized hyperparameters and resource placement(s) for an AI job(s). Lowest cost, highest performance deployment prediction 204 may be provided by predictive modeling engine 202 to server 101 for use in other components of the full lifecycle AI workload deployment system (e.g., deployment component 104).

In some examples, predictive modeling component 102 may be implemented as a standalone tool to provide insights into expected system performance under various deployment scenarios. A user may leverage this capability to: (a) understand resource requirements for a given AI workload; (b) simulate an impact of different hyperparameters and parallelization strategies; and (c) optimize deployment decisions for training, fine-tuning, or inference tasks. For example, a predictor tool comprising predictive modeling component 102 may be used as a pre-sales assessment tool to assess resource requirements of enterprises during project initiation or scoping of resource requirements. The input to the pre-sales predictor tool can include a use case (e.g., AI-based document summarization, agentic AI use cases, AI-based drug discovery, financial use cases, etc) and a target specification of the use case (e.g., the number of documents, expected number of users, performance SLAs, target latency, target throughput, accuracy, carbon efficiency, number of users, total budget, etc). The predictor tool can compute the number of required GPUs, type of GPUs, cost, carbon footprint, infrastructure connectivity and architecture, and performance metrics. It can even suggest the target AI model for the given use case (or the user can specify the AI model as an input). A predictor tool can be used in green-field deployments where a user is planning to build in-house servers to estimate needs to set up their infrastructure from the ground up. A predictor tool also may be used in brown-field deployments where the user already has an infrastructure and to estimate model performance and cost of a current setup. A predictor tool further can be used for cloud deployments to understand the performance and cost using cloud GPU providers. A predictor tool can also be used as a capacity planning tool to compare the performance of different accelerators such as different Nvidia GPUs, AMD GPUs, Google TPUs, or other hardware accelerators.

In some examples, predictive modeling component 102 also may integrate runtime data to continuously adapt deployment strategies based on real-time system states. A dynamic orchestration may be useful for: (a) managing training, fine-tuning, or inference workloads with evolving requirements; (b) ensuring efficient resource utilization during periods of high system activity; and (c) responding to job failures or delays with minimal impact on overall performance.

Returning to FIG. 1, deployment component 104 may deploy the AI job within an AI infrastructure using server 101 (e.g., on premise physical servers, cloud server, hybrid server, etc.). In some examples, deployment component 104 may leverage open source and/or proprietary software to ensure seamless integration and execution. In some examples, a user-friendly and intuitive interface may be provided for a user to interact with both bare-metal clusters and existing resource schedulers (e.g., Ray, Kubernetes, OpenShift, Docker, GCP, Azure Container Apps, AWS EKS, Slurm, and the like).

In some examples, monitoring component 106 may utilize cluster-level metrics and semantic computation graph tracking to provide comprehensive visibility into system performance. For example, resource tracking may be performed by monitoring GPU resource utilization based on AI model usage to identify potential bottlenecks and inefficiencies. Monitoring component 106 may collect fine-grained GPU and kernel metrics, CUDA events, and GPU hardware counters to deliver comprehensive data for detailed analysis and efficient troubleshooting. Monitoring component 106 may achieve more accurate and fine-grained measurement of actual GPU utilization by collecting data on the number of threads or warps being executed at a given point in time and analyzing this data in conjunction with the architecture of the AI model, including its parallelization strategy and hyperparameters (e.g., as provided by predictive modeling component 102) to determine the actual GPU utilization. In some examples, monitoring component 106 also may quantify how much a current application can still be accelerated, thereby determining GPU efficiency. This approach enables a user to identify potential room to optimize their AI model execution and improve overall system performance.

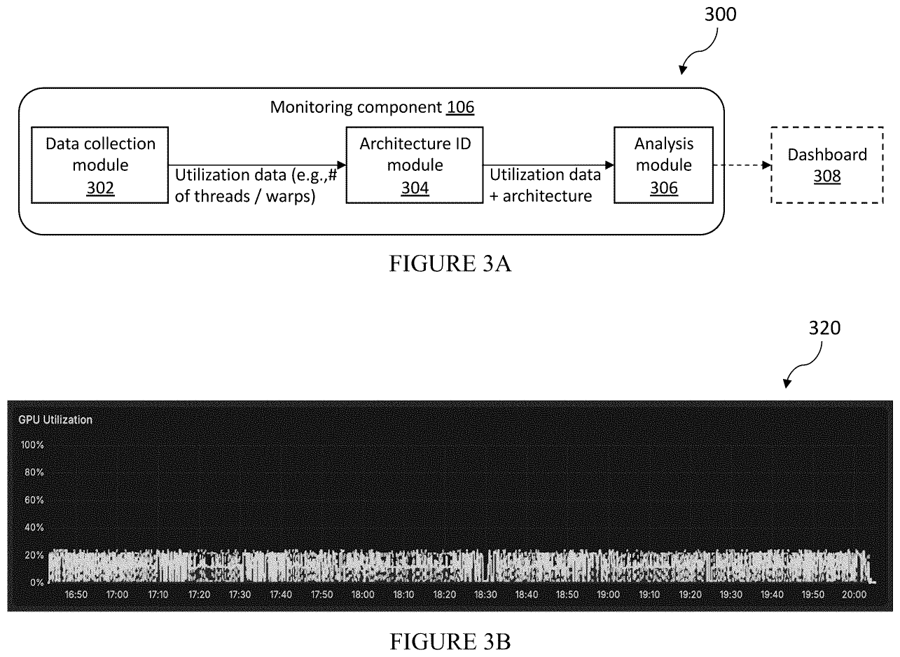

FIG. 3A is a simplified block diagram illustrating exemplary modules in a monitoring component of a full lifecycle AI workload deployment with cost and performance optimization, in accordance with one or more embodiments. In diagram 300, monitoring component 106 (e.g., from FIG. 1) may include data collection module 302, architecture identification module 304, and analysis module 306. In some examples, data collection module 302 may be configured to collect utilization data on a number of threads or warps being executed at a given point in time within the GPU (e.g., a GPU deploying one or more jobs of the AI model). This fine-grain utilization data collected by data collection module 302 is in contrast to existing methods of estimating a fraction of time at least one streaming multiprocessor (SM) core has something to run. The fine-grain utilization data comprising a number of threads or warps being executed at a given point in time within the GPU may be provided to architecture identification module 304, where the architecture of the AI model being executed on the GPU may be identified, including its parallelization strategy and hyperparameters. In some examples, architecture identification module 304 may use machine learning algorithms to identify the AI model architecture. In other examples, architecture identification module 304 may use a database lookup to identify the AI model architecture. The utilization data and identified architecture (e.g., including parallelization strategy and hyperparameters) may be provided to analysis module 306 for determination of actual GPU utilization and efficiency. In some examples, analysis module 306 may use mathematical formulas or other algorithms to calculate actual GPU utilization and efficiency based on the fine-grain utilization data and the identified architecture. Actual GPU utilization and efficiency may include both fine-grain utilization data and a measure of GPU efficiency quantifying an amount that a current application can still be accelerated (e.g., remaining available performance headroom). The actual GPU utilization and efficiency metric may be derived (e.g., by analysis module 306) by analyzing a number of CUDA operations that can be further parallelized and measuring remaining overhead and bottlenecks in one, or a combination, of CPU processing, network traffic, data transfers, and memory allocation. Therefore, the actual GPU utilization and efficiency metric calculated by analysis module 306 may indicate additional performance headroom that can be leveraged, in addition to fine-grain actual GPU utilization.

In some examples, the actual GPU utilization and efficiency calculated by analysis module 306 may be provided to a dashboard 308 to display a chart or other graphic representation of the actual GPU utilization and efficiency (e.g., on a display, user interface, etc.). FIG. 3B is a chart showing true GPU utilization and efficiency as monitored by a full lifecycle AI workload deployment with cost and performance optimization, in accordance with one or more embodiments. Chart 320 is an example of a graphic representation of the actual (i.e., true) GPU utilization, as may be determined by monitoring component 106 prior to implementation of optimizations described below. In some examples, an efficiency metric of the GPU may be derived using chart 320. In contrast, prior art tools that estimate GPU utilization by reporting a fraction of time at least one SM core has something to run provide an overestimation of GPU utilization, indicating almost 100% GPU utilization for the same implementation.

In some examples, a real-time monitoring dashboard (e.g., dashboard 308) may integrate predictions and semantic computation graphs to: (a) inform a user about current system performance metrics and expected future states; (b) visualize bottlenecks and performance trends across the AI infrastructure; and (c) provide actionable insights for maintaining system health and efficiency. In some examples, monitoring component 106 may be implemented independently as an auditor of AI deployments to monitor a current deployment and identify potential opportunities for performance optimizations, including checking against target service level agreements (SLAs) of a job in real-time to suggest alternative deployments (e.g., changing a type of GPU, a cloud provider, etc.).

The recording of processing time and performance metrics for each AI computation operation (e.g., by monitoring component 106) may capture semantic behavior within an AI infrastructure (e.g., using a DAG of the AI model, as described herein). This enables semantic-aware graph analysis and identification of potential operations that would benefit from optimizing resource allocation and performance (e.g., by other components described herein), even in the presence of dynamic and uncertain workload conditions. In some examples, each node in a graph (e.g., DAG or other computation graph) may represent a compute operation (e.g., as an N×M matrix multiplication, other granular representation of a compute operation, etc.) with connections indicating data dependencies. A DAG or other operation graph (i.e., computation graph) of an AI model may be profiled (e.g., by data collection module 302) to capture its behavior under various input scenarios. This approach (e.g., the predictive modeling and monitoring aspects described herein) accounts for a wide range of parameters that impact AI deployment performance, including concurrency, input sequence length, output sequence length, parallelization strategy, model family, model size, type of GPU, and other hyperparameters. By analyzing relationships between these parameters and a target performance of the AI model, the system may accurately predict resource requirements, including compute resources and memory usage, under different deployment scenarios. According to the methods described herein, data collection module 302 may be configured to collect data on performance of an AI model under various (i.e., a plurality of) scenarios, including measurements of compute time and memory usage for different compute operations, such as transformer blocks and CUDA kernels. This fine-grain utilization data may be used to inform predictions about resource requirements (e.g., number of required replicas, memory demand, latency, etc.) under any input scenarios (e.g., including not explicitly profiled, determined using the mathematical formulations described herein), thereby enabling adaptation to changes in workload and or to the AI model itself.

In some examples, troubleshooting component 108 integrates insights from predictive modeling component 102 and monitoring component 106 to diagnose and resolve system performance issues. Troubleshooting component 108 may perform semantic-aware analysis of an operation graph (e.g., DAG and other computation graphs) and comparison of execution times (e.g., from monitoring component 106) against predictions (e.g., from predictive modeling component 102) to identify discrepancies pointing to performance bottlenecks, from which targeted optimization efforts may be derived. A detailed analysis of the call stack enables isolation of issues and can be used to provide actionable recommendations to improve system reliability and debugging efficiency. Troubleshooting component 102 may be configured to suggest (i.e., recommend) remedial actions based on its analysis, enabling users to quickly and effectively address performance problems and prevent future occurrences.

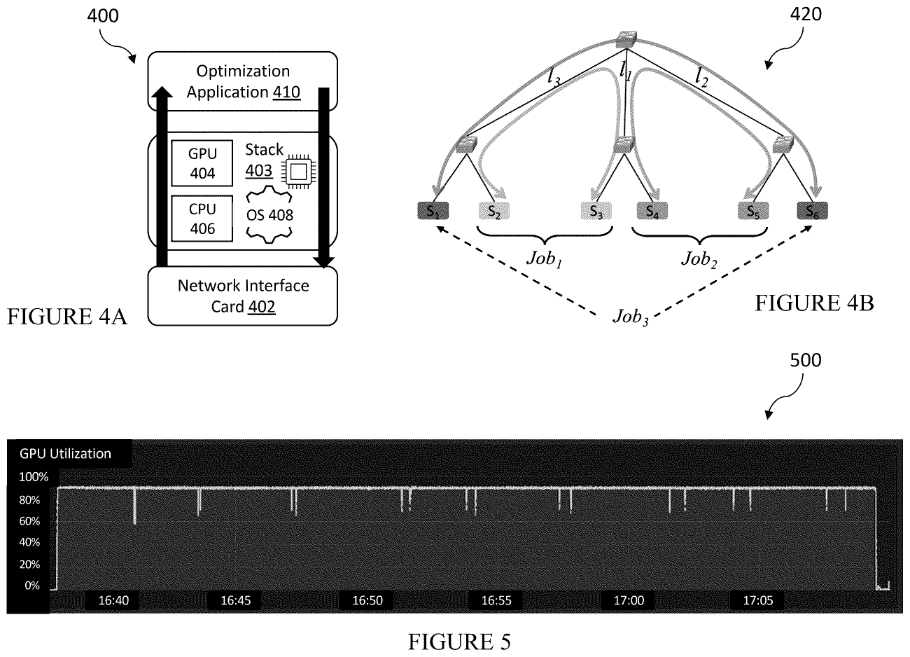

In some examples, performance optimization component 110 may be configured to employ a range of techniques to address bottlenecks and enhance performance based on insights (e.g., remedial actions and targeted optimization recommendations) from troubleshooting component 108. Performance optimization component 110 may perform workload placement adjustments, as well as implement improved scheduling and efficient collective communication. These performance optimizations may result in faster training, fine-tuning, inference, and agentic deployments, while reducing energy consumption and resource overhead. Performance optimization component 110 may optimize AI model performance across the full-stack with multi-tenancy benefits. FIG. 4A is a simplified block diagram illustrating an exemplary full stack system-level optimization by a full lifecycle AI workload deployment, in accordance with one or more embodiments. In system 400, the entire pipeline, from data ingestion and preprocessing (e.g., by network interface card 402) to GPU execution and output (e.g., at/by GPU 404) is optimized to ensure that costly GPU cycles are not being wasted waiting on, for example, CPUs (e.g., CPU 406), memory (e.g., as managed by OS 408), network transfers (e.g., by network interface card 402), and other parts of stack 403. Performance optimization application 410 may be configured to efficiently move and schedule data and jobs across the network (e.g., accessed using network interface card 402), CPU (e.g., CPU 406), system memory (e.g., managed by OS 408), and GPU (e.g., GPU 404) of an AI server based on insights and recommendations from troubleshooting component 108.

In addition to system-level optimizations, predictive modeling engine 202 may be configured to select, and performance optimization component 110 also may be configured to employ, multi-tenancy optimizations. Multi-tenancy optimizations may employ automated run-time AI orchestration, addressing challenges such as contention, stragglers, and fluctuating availability in shared environments. FIG. 4B is a simplified system diagram illustrating a multi-tenancy scenario, in accordance with one or more embodiments. In diagram 420, jobs 1-3 (Job₁, Job₂, and Job₃) are being executed by servers 1-6 (S₁, S₂, S₃, S₄, S₅, S₆), each server comprising GPUs. Jobs 1-3 are therefore competing for resources such as network, GPUs, and storage. GPUs from S₁ and S₆ are workers assigned to Job₃, GPUs from S₂ and S₃ are workers assigned to Job₁, and GPUs from S₄ and S₅ are workers assigned to Job₂. Arrows show communication occurring via links 1-3 (l₁, l₂, l₃) between nodes (e.g., the servers being associated with some of the nodes) in order to facilitate the jobs shown, the arrows colliding on network links indicating competition for network resources. Such network collisions and resource inefficiencies may be minimized, or avoided, by deployment optimizations predicted, deployed, and implemented by components described herein.

Predictive modeling engine 202, as described herein, is able to simulate a vast space of hyperparameters and parallelization strategies, selecting a deployment configuration that yields optimal trade-offs between performance and cost given a set of relevant constraints (e.g., current network and resource constraints, hyperparameters, budgets, and other objectives). The framework described herein enables dynamic prediction and adaptation to real-time cluster conditions, allocating resources with precision and optimizing for cost, performance, and service-level agreement constraints across heterogeneous enterprise environments. This framework is universally compatible, ensuring that each GPU is delivering optimal effective throughput alongside model-level enhancements. FIG. 5 is a chart showing true GPU utilization and efficiency of a full lifecycle AI workload deployment with cost and performance optimization, in accordance with one or more embodiments. In chart 500, actual GPU utilization (e.g., as determined by monitoring component 106) is being shown for an exemplary AI model deployment after application of the optimization techniques described herein.

In some examples, a predictive engine and semantic computation graph, as described herein, may be combined into an analysis tool to help a user: (a) simulate performance impact of different hardware and software configurations, (b) compare cost and performance trade-offs for potential investment, and (c) identify an optimal infrastructure setup for a workload. In some examples, the framework may be extended to support scalable and low-latency edge inference for online applications, to achieve: (a) real-time processing, cost efficiency, and enhanced user experience.

### Example Methods

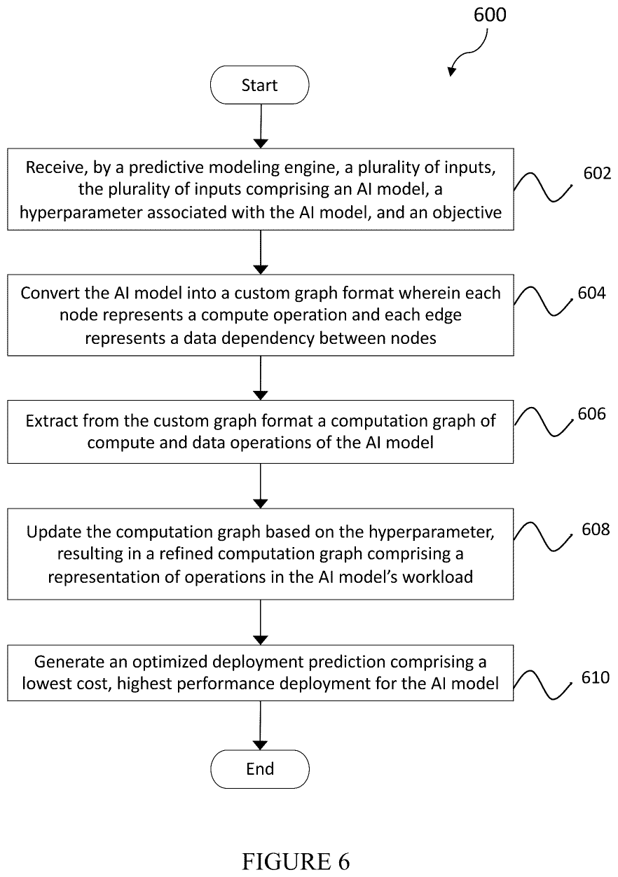

FIG. 6 is a flow diagram illustrating a method for generating an optimized deployment prediction in a full lifecycle AI workload deployment with cost and performance optimization, in accordance with one or more embodiments. In method 600, a plurality of inputs may be received by a predictive modeling engine at step 602. In some examples, the plurality of inputs may include an AI model, a hyperparameter associated with the AI model (e.g., resource requirements, cost and performance efficiency targets, a parallelization strategy, a learning rate, a job placement strategy, results of a collective communication operation (e.g., AllReduce collective), global and local batch sizes, and other parameters), and an objective (e.g., target accuracy, time budget, cost budget, job priority, etc.). In some examples, the plurality of inputs also may include a dataset. The AI model may be converted to a custom graph format at step 604, wherein each node of the custom graph format represents a compute operation and each edge represents a data dependency between nodes. A computation graph (e.g., a DAG, as described herein) may be extracted from the custom graph format at step 606, the computation graph comprising a representation (i.e., comprehensive representation) of the compute and data operations of the AI model. The computation graph may be updated at step 608 based on the hyperparameter, resulting in a refined computation graph comprising a representation of operations in the AI model's workload. In some examples, the computation graph also may be updated according to one or more triggers, including job and/or user arrival, job departure, failures, stragglers, and the like. An optimized deployment prediction comprising a lowest cost, highest performance deployment for the AI model may be generated at step 610, including optimized hyperparameters and resource placements for an AI jobs. In some examples, the optimized deployment may be provided to other components in a full lifecycle AI workload deployment system, as described herein.

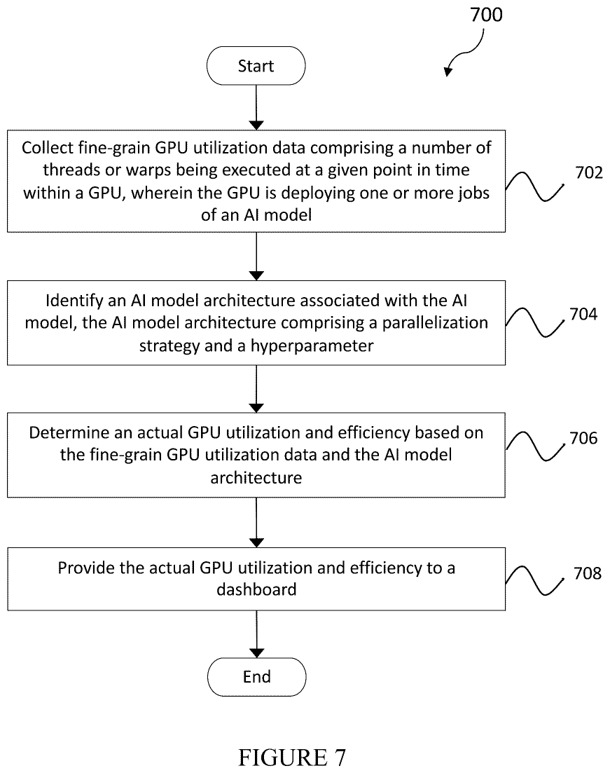

FIG. 7 is a flow diagram illustrating a method for determining actual GPU utilization and efficiency in a full lifecycle AI workload deployment with cost and performance optimization, in accordance with one or more embodiments. In method 700, fine-grain GPU utilization data may be collected at step 702, the fine-grain GPU utilization data comprising a number of threads or warps being executed at a given point in time within a GPU, wherein the GPU is deploying one or more jobs of an AI model. An AI model architecture associated with the AI model may be identified at step 704, the AI model architecture comprising a parallelization strategy and a hyperparameter. An actual GPU utilization and efficiency may be determined based on the fine-grain GPU utilization data and the AI model architecture at step 706. As described herein, the actual GPU utilization and efficiency may comprise a metric indicating both an accurate measure of GPU utilization data and an indication of remaining performance headroom that can be leveraged. The actual GPU utilization and efficiency may be provided to a dashboard at step 708.

### Example Computing Systems

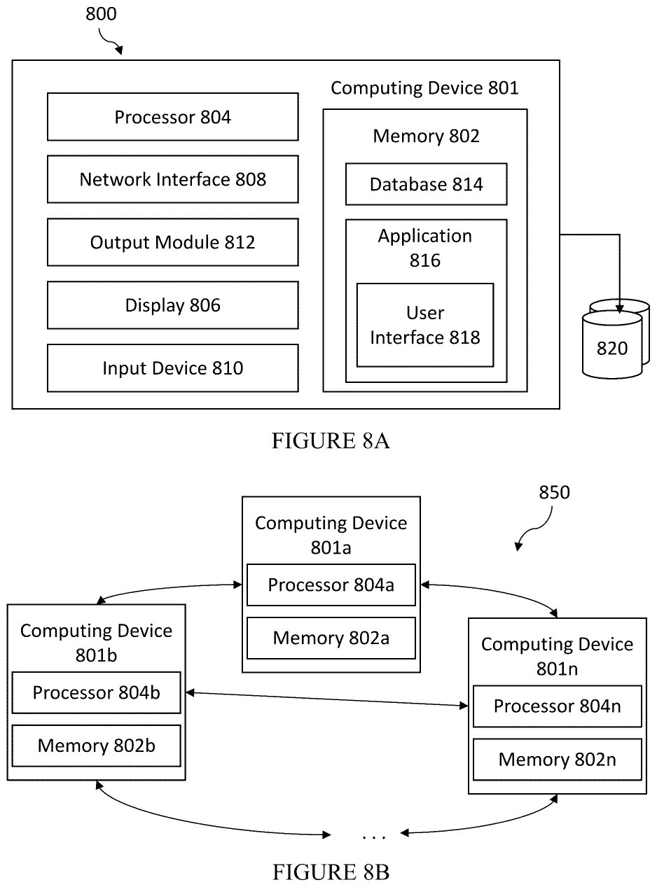

FIG. 8A is a simplified block diagram of an exemplary computing system configured to implement the systems shown in FIGS. 1-2, 3A, 4A-4B and to perform steps of the method illustrated in FIGS. 6-7, in accordance with one or more embodiments. In one embodiment, computing system 800 may include computing device 801 and storage system 820. Storage system 820 may comprise a plurality of repositories and/or other forms of data storage, and it also may be in communication with computing device 801. In another embodiment, storage system 820, which may comprise a plurality of repositories, may be housed in one or more of computing device 801. In some examples, storage system 820 may store data and datasets (e.g., GPU utilization, timestamps, other measurements and metrics, etc.), hyperparameters and other parameters, preferences, instructions, programs, AI models, other models, and other various types of information as described herein. This information may be retrieved or otherwise accessed by one or more computing devices, such as computing device 801, in order to perform some or all of the features described herein. Storage system 820 may comprise any type of computer storage, such as a hard-drive, memory card, ROM, RAM, DVD, CD-ROM, write-capable, and read-only memories. In addition, storage system 820 may include a distributed storage system where data is stored on a plurality of different storage devices, which may be physically located at the same or different geographic locations (e.g., in a distributed computing system such as system 850 in FIG. 8B). Storage system 820 may be networked to computing device 801 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 801 also may include a memory 802. Memory 802 may comprise a storage system configured to store a database 814 and an application 816. Application 816 may include instructions which, when executed by a processor 804, cause computing device 801 to perform various steps and/or functions, as described herein. Application 816 further includes instructions for generating a user interface 818 (e.g., graphical user interface (GUI)). Database 814 may store various algorithms and/or data, including neural networks, AI models, other models, data regarding GPU utilization and efficiency, AI models, AI architectures, hyperparameters, user preferences, among other types of data. Memory 802 may include any non-transitory computer-readable storage medium for storing data and/or software that is executable by processor 804, and/or any other medium which may be used to store information that may be accessed by processor 804 to control the operation of computing device 801.

Computing device 801 may further include a display 806, a network interface 808, an input device 810, and/or an output module 812. Display 806 may be any display device by means of which computing device 801 may output and/or display data. Network interface 808 may be configured to connect to a network using any of the wired and wireless short range communication protocols described above, as well as a cellular data network, a satellite network, free space optical network and/or the Internet. Input device 810 may be a mouse, keyboard, touch screen, voice interface, and/or any or other hand-held controller or device or interface by means of which a user may interact with computing device 801. Output module 812 may be a bus, port, and/or other interface by means of which computing device 801 may connect to and/or output data to other devices and/or peripherals.

In one embodiment, computing device 801 is a data center or other control facility (e.g., configured to run a distributed computing system as described herein), and may communicate with a media playback device or other video player or client device. As described herein, system 800, and particularly computing device 801, may be used for predictive modeling, extracting computation graphs, analyzing (e.g., GPU utilization), generating metadata, natural language processing, implementing AI models, generating predictions and optimization insights, and otherwise implementing steps in generating and integrating sign language into video streams, as described herein. Various configurations of system 800 are envisioned, and various steps and/or functions of the processes described herein may be shared among the various devices of system 800 or may be assigned to specific devices.

FIG. 8B is a simplified block diagram of an exemplary distributed computing system implemented by a plurality of the computing devices, in accordance with one or more embodiments. System 850 may comprise two or more computing devices 801a-n. In some examples, each of 801a-n may comprise one or more of processors 804a-n, respectively, and one or more of memory 802a-n, respectively. Processors 804a-n may function similarly to processor 804 in FIG. 8A, as described above. Memory 802a-n may function similarly to memory 802 in FIG. 8A, as described above. One or more computing devices 801a-n may implement a server-side processer, as described herein. One or more other of computing devices 801a-n may implement a client-side processor or component, as described herein.

While specific examples have been provided above, it is understood that the present invention can be applied with a wide variety of inputs, thresholds, ranges, and other factors, depending on the application. For example, the time frames, rates, ratios, and ranges provided above are illustrative, but one of ordinary skill in the art would understand that these time frames and ranges may be varied or even be dynamic and variable, depending on the implementation.

As those skilled in the art will understand a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A system for deploying artificial intelligence (AI) workloads comprising:
a server implementing a memory comprising non-transitory computer-readable storage medium and one or more processors,
the memory comprising non-transitory computer-readable storage medium configured to store an AI model, a dataset, and processing unit (GPU) utilization data,
the one or more processors configured to execute instructions stored on the non-transitory computer-readable storage medium to implement:
a predictive modeling engine to provide an optimized deployment prediction comprising a lowest cost, highest performance deployment,
a data collection module to collect the GPU utilization data on performance of the AI model under a plurality of scenarios,
an architecture identification module to identify an AI model architecture associated with the AI model,
an analysis module to determine an actual GPU utilization and efficiency based on the GPU utilization data and the AI model architecture,
a performance optimization application to implement workload placement adjustments, including moving and scheduling data across a full stack implementation of an AI infrastructure associated with the AI model architecture.

2. The system of claim 1, wherein the lowest cost, highest performance deployment comprises an optimized hyperparameter and an optimized resource placement for an AI job.

3. The system of claim 1, wherein the server comprises one, or a combination of, an on-premise server, a cloud server, and a hybrid server.

4. The system of claim 1, wherein the GPU utilization data comprises fine-grain utilization data including a number of threads or warps being executed at a given point in time within a GPU.

5. The system of claim 1, wherein the GPU utilization data comprises one, or a combination, of GPU and kernel metrics, CUDA events, and GPU hardware counters.

6. The system of claim 1, wherein the architecture identification module is configured to use one or both of a machine learning algorithm and a database lookup to identify the AI model architecture.

7. The system of claim 1, wherein the one or more processors is further configured to execute instructions to implement a deployment module to deploy an AI job using the optimized deployment prediction.

8. The system of claim 7, wherein the deployment module is configured to integrate open source and/or proprietary tools to deploy the AI job.

9. The system of claim 1, wherein the one or more processors is further configured to execute instructions to implement a troubleshooting component to perform semantic-aware analysis of an operation graph and comparison of execution time against the prediction by the predictive modeling engine.

10. The system of claim 9, wherein the operation graph comprises a computation graph.

11. The system of claim 10, wherein the computation graph is a Directed Acyclic Graph (DAG).

12. The system of claim 9, wherein the troubleshooting component is configured to compare a predicted execution time of the optimized deployment prediction with an actual metric of the actual GPU utilization and efficiency to identify a performance bottleneck.

13. The system of claim 1, wherein the predictive modeling engine is configured to perform one, or a combination, of mathematical modeling, simulations, hardware profiling, and software profiling to enhance resource forecasting and accuracy in the optimized deployment prediction.

14. The system of claim 1, wherein the predictive modeling engine is configured to convert the AI model into a custom graph format wherein each node represents a compute operation and each edge represents a data dependency between nodes.

15. The system of claim 1, wherein the predictive modeling engine is configured to extract a computation graph from the AI model, and to update the computation graph based on a hyperparameter.

16. The system of claim 15, wherein the computation graph comprises a Directed Acyclic Graph (DAG).

17. The system of claim 1, wherein the predictive modeling engine is configured to perform single accelerator projection, including profiling on a single hardware accelerator and projecting execution times across different parallelization strategies.

18. The system of claim 1, wherein the analysis module is configured to perform semantic graph analysis on a computation graph representing the AI model to determine and record performance metrics for each computation operation in the AI model.

19. The system of claim 1, wherein the optimized deployment prediction reflects one, or a combination, of a parallelization strategy, a learning rate, a job placement strategy, a result of a collective communication operation, a global batch size, and a local batch size.
